(19) United States
(12) Patent Application Publication
(10) Pub. No.: US 2010/0257095 A1
(43) Pub. Date: Oct. 7, 2010

(54) CASH-ON-HAND ACCOUNT

(76) Inventor: Andrew Porterfield, Kansas City, MO (US)

Correspondence Address: ITALIA IP, 3500 WEST OLIVE AVE., SUITE 300, BURBANK, CA, 91505, US

(21) Appl. No.: 12/418,067

(22) Filed: Apr. 3, 2009

(51) Int. Cl. G06Q 40/00

(52) U.S. Cl. 705/42; 705/35; 705/39

(57) ABSTRACT

A banking system includes terminals and a computer operable to act as a server on a network and to communicate with each terminal. The computer includes a memory configured to store a set of instructions and a processor configured to execute the instructions. The instructions cause the processor to: receive a deposit request from a terminal, the request comprises an amount of funds to be deposited, and instructions indicating a percentage of the funds to be deposited into a cash-on-hand account; credit the account with an amount of funds equivalent to the percentage of the deposited funds instructed therefor; and transfer funds to a cash-on-hand reserve, wherein the amount of funds transferred to the reserve is equivalent to the amount of funds credited to the account. The funds transferred to the reserve are not eligible for conventional banking activities, and the reserve is only diminished by withdrawals from the account.

### BACKGROUND OF INVENTION

This application relates generally to a banking system and method. More particularly, this application relates to a system and method for safely and securely storing cash assets in a banking institution.

### SUMMARY

With economic downturns, such as recessions and depressions, maintaining one's wealth in a banking institution becomes increasingly risky. The Federal Government has attempted to alleviate this risk by maintaining the Federal Deposit Insurance Corporation (FDIC) to guarantee banking customers' accounts up to a specified amount. Nevertheless, it still remains possible that banking institution failures may occur in such vast numbers and with such frequency that the FDIC may become overextended and unable to fulfill banking customer insurance claims. Described herein is a banking system and method for safely and securely storing cash assets in a banking institution.

In one embodiment, a banking system comprises: one or more participant terminals operable to act as a client on a network; a computer operable to act as a server on the network and to communicate with each of the participant terminals over the network, the computer comprising: a memory configured to store a set of instructions; and a processor configured to execute the set of instructions, wherein the set of instructions cause the processor to: receive a deposit request from at least one of the terminals, wherein the deposit request comprises an amount of funds to be deposited, and instructions indicating a percentage of the funds to be deposited into a cash-on-hand account of a customer and a percentage of the funds to be deposited into a second account of the customer; credit the customer cash-on-hand account with an amount of funds equivalent to the percentage of the deposited funds instructed therefor; and transfer funds to a cash-on-hand reserve, wherein the amount of funds transferred to the cash-on-hand reserve is equivalent to the amount of funds credited to the customer cash-on-hand account, and wherein the funds transferred to the cash-on-hand reserve are not eligible for conventional banking activities, and wherein the cash-on-hand reserves are only diminished by the customer withdrawing funds from the cash-on-hand account.

In another embodiment, a bank account comprises: means for receiving deposited funds from a plurality of users and creating a cash-on-hand reserve; means for electronically pooling the deposited funds, thereby generating an electronic pooled fund, such that the electronic pooled fund is equal to the cash-on-hand reserve; means for separately accounting for the users deposited funds in the electronically pooled fund; and means for allowing a user to withdraw its deposited funds from the electronically pooled fund, such that the pooled fund is diminished by the withdrawn amount and such that the electronically pooled fund amount remains equal to the cash-on-hand reserve.

In yet another embodiment, a computer program product, comprising a computer usable medium having a computer readable program code embodied therein, said computer readable program code adapted to be executed to implement a method for managing funds, said method comprising: receiving a deposit request, wherein the deposit request comprises an amount of funds to be deposited, and instructions indicating a percentage of the funds to be deposited into a cash-on-hand account of a customer and a percentage of the funds to be deposited into a second account of the customer; crediting the customer cash-on-hand account with an amount of funds equivalent to the percentage of the deposited funds instructed therefor; and transfer funds to a cash-on-hand reserve, wherein the amount of funds transferred to the cash-on-hand reserve is equivalent to the amount of funds credited to the customer cash-on-hand account, and wherein the funds transferred to the cash-on-hand reserve are not eligible for conventional banking activities, and wherein the cash-on-hand reserves are only diminished by the customer withdrawing funds from the cash-on-hand account.

### BRIEF DESCRIPTION OF THE DRAWINGS

The drawings, when considered in connection with the following description, are presented for the purpose of facilitating an understanding of the subject matter sought to be protected.

FIG. 1 is an pictorial diagram of an illustrative embodiment of a banking system disclosed herein.

### DETAILED DESCRIPTION

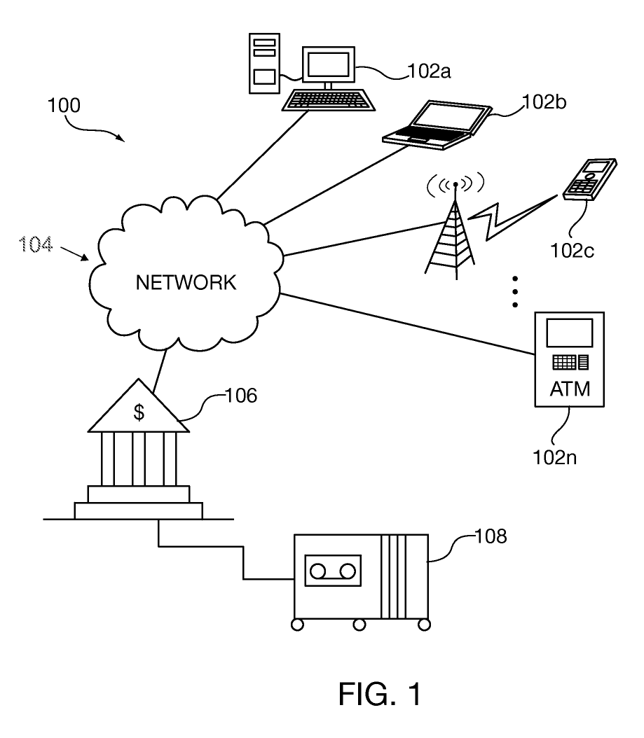

Referring now to FIG. 1, a banking system 100 is shown. The banking system 100 generally includes one or more terminals 102a-102n (collectively 102), a communications network 104, a banking institution 106, and a server 108. The different elements and components of the system 100 may communicate with one another using wireless communications or hardwired connections, such as fiber optics, cable, DSL, telephone lines, and other similar connections.

The terminals 102 may include any suitable device operable to act as a client on a network. Illustrative terminals 102 include, but are not limited to, personal computers, desktop computers, laptop computers, servers, automatic teller machines (ATMS) or any suitable telecommunications device, including, but not limited to, VoIP telephones, smart telephones or wireless devices, such as cellular telephones, personal digital assistants (PDA), communications enabled mp3 players, etc. Each terminal 102 may be configured to transmit and/or receive information to and/or from the server 108. In one embodiment, at least one terminal is operated by a banking institution 106 employee, such as a teller. In an alternative embodiment, at least one terminal is operated directly by a customer of the banking institution 106.

The communications network 104 may include any number of networks capable of providing communications between the server 108 and terminals 102. For example, the communications network may be one or more, or any combination of, wireless networks, data or packet networks, publicly switched telephone networks (PSTN), etc.

The banking institution 106 may be any suitable banking organization, including, but not limited to a bank, a credit union, etc. The banking institution 106 may house the server 108 or the server may be housed off-site. The banking institution 106 may provide various services, including managing and maintaining customer accounts, processing transaction information, facilitating fund transfers, extending lines of credit, transferring payments for transactions performed by an individual, and facilitating settlement processes associated with inter-institutional transactions.

The server 108 may be any server, computer or device configured to process commands from the terminals 102. In one embodiment, the server includes memory for storing a set of instructions and a processor for executing the instructions. The processor may access information from, and store information in, a nonremovable memory or a removable memory, also collectively referred to herein as computer readable media. The nonremovable memory may consist of RAM, ROM, a hard disk, or other well-known memory storage technologies. The removable memory may consist of one or more Subscriber Identity Module (SIM) cards, or other well-known memory storage technologies, such as “smart cards,” magnetic disks, floppy disks, optical disks, magneto-optical disks, magnetic tapes, or any suitable non-volatile memory. Furthermore, while the following is generally performed by the server 108, it will be appreciated that any suitable bank employee or affiliate may perform one or more of the following functions.

In the illustrative embodiment, the server 108 is operable to receive one or more deposit requests from one or more terminals 102. In one embodiment, the deposit request includes an amount of funds to be deposited and instructions indicating percentage of the funds to be deposited into a cash-on-hand account of the customer and a percentage of funds to be deposited into a second account of the customer. The second account of the customer may be any suitable account, including, but not limited to, a savings account, a money market account, a checking account or any other suitable account. The server 108 may also be operable to receive other requests from the terminal(s) 102, including, but not limited to, withdrawal requests, transfer requests, account balance requests, etc.

Once the deposit request is received, the cash-on-hand account of the customer is credited with an amount of funds equivalent to the percentage of funds instructed therefor. In one embodiment, the customer's second account is also credited with an amount of funds equivalent to the percentage of funds instructed therefor. The server 108 may maintain a record of the amount of cash-on-hand funds deposited into each cash-on-hand account of each customer.

Once each customer account is credited, funds are transferred to a cash-on-hand reserve maintained by the banking institution 106 either on-site or off-site. The amount of funds transferred to the cash-on-hand reserve may be equivalent to the amount of funds transferred to each customer cash-on-hand account. The cash-on-hand reserve may be a physical or an electronically pooled fund comprising all funds deposited into customer cash-on-hand accounts. As will be discussed further, if the cash-on-hand reserve is an electronically pooled fund, the system may periodically generate a request for a cash equivalent of the amount of funds deposited into the cash-on-hand reserve. Once the funds are transferred to the cash-on-hand reserve, the funds therein are not eligible for use in conventional banking activities, including, but not limited to, loans, leveraging, etc. Furthermore, in one embodiment, the funds in the cash-on-hand reserve are only diminished by customer withdrawals from respective cash-on-hand accounts. Customers may withdraw funds from respective cash-on-hand accounts via any suitable means, including, but not limited to, ATM withdrawals, teller withdrawals, online-banking transfers, etc. In one embodiment, customers may transfer funds to and from respective cash-on-hand accounts, and thus the cash-on-hand reserve, to more traditional banking accounts, such as savings, checking, money-market, etc. Also, in one embodiment, the banking institution 106 may charge each customer a service charge for employing a cash-on-hand account.

Moreover, in one embodiment, once the funds are transferred to the cash-on-hand reserve, the server 108 may generate a request for actual cash to be physically delivered to and/or deposited at the banking institution 106 or a site maintained or otherwise affiliated with the banking institution 106. In one embodiment, the amount of cash requested in equivalent to the amount of funds deposited into the cash-on-hand reserve. The cash may be stored in a special vault, a deposit box or any other suitable means or mechanism for safely and securely storing the cash. The cash may be any suitable currency, including, but not limited to, monetary asset(s), precious metal(s), etc. The cash may be received, or otherwise transferred, from another reserve or fund maintained by the banking institution 106, a sister institution, another banking institution, the Federal Reserve, or the like. In one embodiment, if a customer later withdraws, or otherwise transfers, funds from a cash-on-hand account, a notification may be generated indicating that an amount of cash equal to the withdrawal may be physically removed from, or otherwise made available for conventional banking activities of, the banking institution 106.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A banking system comprising:
one or more participant terminals operable to act as a client on a network;
a computer operable to act as a server on the network and to communicate with each of the participant terminals over the network, the computer comprising:
a memory configured to store a set of instructions; and
a processor configured to execute the set of instructions, wherein the set of instructions cause the processor to:
receive a deposit request from at least one of the terminals, wherein the deposit request comprises an amount of funds to be deposited, and instructions indicating a percentage of the funds to be deposited into a cash-on-hand account of a customer and a percentage of the funds to be deposited into a second account of the customer;
credit the customer cash-on-hand account with an amount of funds equivalent to the percentage of the deposited funds instructed therefor; and
transfer funds to a cash-on-hand reserve, wherein the amount of funds transferred to the cash-on-hand reserve is equivalent to the amount of funds credited to the customer cash-on-hand account, and wherein the funds transferred to the cash-on-hand reserve are not eligible for conventional banking activities, and wherein the cash-on-hand reserve is only diminished by the customer withdrawing funds from the cash-on-hand account.

2. The system of claim 1 wherein the second account of the customer is a savings account.

3. The system of claim 1 wherein the second account of the customer is a money market account.

4. The system of claim 1 wherein the second account of the customer is a checking account.

5. The system of claim 1 wherein the percentage of funds withdrawn from the cash-on-hand account is between 0% and 100%.

6. The system of claim 1 wherein the set of instructions further cause the processor to generate a request for an amount of cash equivalent to the amount of funds deposited into the cash-on-hand reserve.

7. The system of claim 6 wherein the cash is a monetary asset.

8. The system of claim 1 wherein the set of instructions further cause the processor to credit the customer second account with an amount of funds equivalent to the percentage of the deposited funds instructed therefor.

9. A bank account comprising:
means for receiving deposited funds from a plurality of users and creating a cash-on-hand reserve;
means for electronically pooling the deposited funds, thereby generating an electronic pooled fund, such that the electronic pooled fund is equal to the cash-on-hand reserve;
means for separately accounting for the users deposited funds in the electronically pooled fund; and
means for allowing a user to withdraw its deposited funds from the electronically pooled fund, such that the pooled fund is diminished by the withdrawn amount and such that the electronically pooled fund amount remains equal to the cash-on-hand reserve.

10. The bank account of claim 9 wherein the means for receiving deposited funds comprises at least one automatic teller machine.

11. The bank account of claim 9 wherein the means for receiving deposited funds comprises at least one computer.

12. A computer program product, comprising a computer usable medium having a computer readable program code embodied therein, said computer readable program code adapted to be executed to implement a method for managing funds, said method comprising:
receiving a deposit request, wherein the deposit request comprises an amount of funds to be deposited, and instructions indicating a percentage of the funds to be deposited into a cash-on-hand account of a customer and a percentage of the funds to be deposited into a second account of the customer;
crediting the customer cash-on-hand account with an amount of funds equivalent to the percentage of the deposited funds instructed therefor; and
transfer funds to a cash-on-hand reserve, wherein the amount of funds transferred to the cash-on-hand reserve is equivalent to the amount of funds credited to the customer cash-on-hand account, and wherein the funds transferred to the cash-on-hand reserve are not eligible for conventional banking activities, and wherein the cash-on-hand reserve is only diminished by the customer withdrawing funds from the cash-on-hand account.

13. The computer program product of claim 12 wherein the second account of the customer is a savings account.

14. The computer program product of claim 12 wherein the second account of the customer is a money market account.

15. The computer program product of claim 12 wherein the second account of the customer is a checking account.

16. The computer program product of claim 12 wherein the percentage of funds instructed to be deposited into the customer cash-on-hand account is between 0% and 100%.

17. The computer program product of claim 12 further comprising the step of generating a request for an amount of cash equivalent to the amount of funds deposited into the cash-on-hand reserve.

18. The computer program product of claim 12 further comprising the step of crediting the customer second account with an amount of funds equivalent to the percentage of the deposited funds instructed therefor.
